(19) United States
(12) Patent Application Publication
(10) Pub. No.: US 2004/0257394 A1
(43) Pub. Date: Dec. 23, 2004

(54) Method for ejecting liquid, liquid ejecting apparatus, computer-readable storage medium, and computer system

(75) Inventors: Yoshiko Hoshiyama, Nagano-ken (JP); Hirokazu Nunokawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/764,599

(22) Filed: Jan. 27, 2004

(30) Foreign Application Priority Data
Jan. 27, 2003 (JP) 2003-017735
Dec. 2, 2003 (JP) 2003-402475

(51) Int. Cl. B41J 29/393

(52) U.S. Cl. 347/19

(57) ABSTRACT

A method for ejecting liquid comprises the steps of: forming an adjustment pattern in a predetermined position on a medium by ejecting liquid onto the medium; determining whether or not to form the adjustment pattern again; and if it is determined that the adjustment pattern is to be formed again, then forming the adjustment pattern again in a position that differs from the predetermined position by ejecting liquid onto the medium.

### CROSS-REFERENCE TO RELATED APPLICATIONS

The present application claims priority upon Japanese Patent Application No. 2003-17735 filed on Jan. 27, 2003 and Japanese Patent Application No. 2003-402475 filed on Dec. 2, 2003, which are herein incorporated by reference.

### BACKGROUND OF THE INVENTION

1. Field of the Invention

The present invention relates to methods for ejecting liquid, liquid ejecting apparatuses, computer-readable storage media, and computer systems.

2. Description of the Related Art

Inkjet printers that carry out printing by ejecting ink onto, for example, paper, cloth, or film are known as liquid ejecting apparatuses that eject liquid onto media. These inkjet printers have the function of printing a predetermined pattern on a medium in order to carry out, for example, ink ejection adjustment or paper feed adjustment. The user can carry out the best-suited adjustment by looking at the predetermined pattern that has been printed and confirming the state in which the pattern is formed. In this way, it is possible to perform high quality printing. (See, for example, pages 1 through 12 and FIGS. 1 through 25 of Japanese Patent Application Laid-open Publication No. 2001-130112.)

Liquid ejecting apparatuses such as the above-mentioned inkjet printers, however, have the following drawbacks. When an adjustment pattern is to be printed again on a medium for further readjustment after printing the adjustment pattern once, it is necessary to use a new medium therefor. This is because the adjustment pattern is always printed on the same position; if an adjustment pattern is again printed on a medium that has already been used once, then it would not be possible to confirm the state in which that adjustment pattern is printed because the adjustment pattern that is printed later will superpose on the adjustment pattern that has already been printed. That is, with conventional apparatuses, it is necessary to use a new medium every time adjustment is to be performed. This has been a problem because it imposes a burden on the user. Particularly, since media such as matte paper, glossy paper, and photographic paper are extremely expensive, the cost becomes considerably high when these types of media are used.

### SUMMARY OF THE INVENTION

The present invention has been made in view of the foregoing issues, and it is an object thereof to reduce the number of media that is used in forming patterns for various kinds of adjustments.

A primary invention for accomplishing the above-mentioned object is a method for ejecting liquid comprising the steps of: forming an adjustment pattern in a predetermined position on a medium by ejecting liquid onto the medium; determining whether or not to form the adjustment pattern again; and if it is determined that the adjustment pattern is to be formed again, then forming the adjustment pattern again in a position that differs from the predetermined position by ejecting liquid onto the medium.

Features and objects of the present invention other than the above will become clear by reading the description of the present specification with reference to the accompanying drawings.

### BRIEF DESCRIPTION OF THE DRAWINGS

In order to facilitate further understanding of the present invention and the advantages thereof, reference is now made to the following description taken in conjunction with the accompanying drawings wherein:

FIG. 1 is a perspective view showing an outside appearance of an inkjet printer;

FIG. 2 is an explanatory diagram of an overall configuration of the inkjet printer;

FIG. 3 is a diagram showing a carriage etc. of the inkjet printer;

FIG. 4 is a diagram showing a carrying section etc. of the inkjet printer;

FIG. 5 is a diagram showing a drive mechanism of the carrying section of the inkjet printer;

FIG. 6 is an explanatory diagram showing an arrangement of nozzles in a head;

FIG. 7 is a block diagram showing a configuration inside a head drive circuit;

FIG. 8 is an explanatory diagram showing ink ejection timings during a forward pass and a return pass;

FIG. 9 is an explanatory diagram showing an example of a printed adjustment pattern;

FIG. 10 is an explanatory diagram showing an example of another printed adjustment pattern;

FIG. 11 is an explanatory diagram showing an example of another printed adjustment pattern;

FIG. 12 is an explanatory diagram showing an example of a setting screen for setting a readjustment pattern;

FIG. 13 is an explanatory diagram showing an example of a printed readjustment pattern;

FIG. 14 is an explanatory diagram showing an example of another printed readjustment pattern;

FIG. 15 is a diagram showing some main processes of a processing procedure of a computer program;

FIG. 16 is a flowchart showing an example of a more detailed procedure of the processes of the computer program;

FIG. 17 is an external view of a computer system; and

FIG. 18 is a block diagram showing a configuration of the computer system.

### DETAILED DESCRIPTION OF THE INVENTION

At least the following matters will be made clear by the explanation in the present specification and the description of the accompanying drawings.

An aspect of the present invention is a method for ejecting liquid comprising the steps of: forming an adjustment pattern in a predetermined position on a medium by ejecting liquid onto the medium; determining whether or not to form the adjustment pattern again; and if it is determined that the adjustment pattern is to be formed again, then forming the adjustment pattern again in a position that differs from the predetermined position by ejecting liquid onto the medium.

According to this method, when an adjustment pattern is to be formed again on a medium after an adjustment pattern has once been formed, since the adjustment pattern that is to be formed again is formed in a position that differs from the position in which the already-formed adjustment pattern has been formed, it is possible to use the same medium even if an adjustment pattern has already been formed on that medium, and therefore, it is possible to reduce the number of media used in forming adjustment patterns.

In the above-mentioned method for ejecting liquid, it is possible that, if an additional adjustment pattern is to be formed on the medium after forming the adjustment pattern again, then the additional adjustment pattern is formed in a position that differs from both the position in which the adjustment pattern has been formed earlier and the position in which the adjustment pattern has been formed again. By forming, in this way, the pattern in a different position when further forming an additional adjustment pattern on the medium after forming the adjustment pattern again, it is possible to use the same medium for further readjustment, and therefore, it is possible to further reduce needless consumption of media.

In the above-mentioned method for ejecting liquid, it is possible that: the adjustment pattern is formed in a plurality of locations on the medium; and adjustment patterns are formed again in correspondence with each of the adjustment patterns that have been formed earlier in the plurality of locations. In this way, it is possible to easily distinguish the correspondence between the adjustment pattern formed earlier and the adjustment pattern formed again.

In the above-mentioned method for ejecting liquid, it is possible that at least either one of the adjustment pattern formed earlier on the medium or the adjustment pattern formed again on the medium is marked in the vicinity thereof with a character for specifying that it is the adjustment pattern formed earlier or a character for specifying that it is the adjustment pattern formed again. By marking such a character in the vicinity of at least either one of the adjustment pattern formed earlier or the adjustment pattern formed again, it is possible to easily specify each of the adjustment pattern formed earlier or the adjustment pattern formed again.

In the above-mentioned method for ejecting liquid, it is possible that the adjustment pattern that is formed again is formed side by side with the adjustment pattern that has been formed earlier, or is formed diagonally adjacent to the adjustment pattern that has been formed earlier.

In the above-mentioned method for ejecting liquid, it is possible that: the adjustment pattern formed earlier and the adjustment pattern formed again are formed by an ejection head that is for ejecting liquid while moving relatively with respect to the medium; and the adjustment pattern that has been formed earlier and the adjustment pattern that has been formed again are patterns for adjusting a misalignment between a position on the medium where the liquid reaches when the ejection head moves in one direction, and a position on the medium where the liquid reaches when the ejection head moves in another direction. Further it is possible that the adjustment pattern that has been formed earlier and the adjustment pattern that has been formed again are patterns for adjusting a carry amount for which the medium is carried.

In the above-mentioned method for ejecting liquid, it is possible that the method further comprises a step of setting the position in which the adjustment pattern is to be formed again. In this way, it is possible to set the position in which the adjustment pattern is to be formed again.

In the above-mentioned method for ejecting liquid, it is possible that: the liquid is ink; and the adjustment pattern formed earlier and the adjustment pattern formed again are printed by ejecting the ink onto the medium.

Another aspect of the present invention is a liquid ejecting apparatus comprising: a liquid ejecting section for ejecting liquid onto a medium, wherein the liquid ejecting apparatus is capable of forming an adjustment pattern in a predetermined position on the medium with the liquid ejecting section, wherein, after forming the adjustment pattern, the liquid ejecting apparatus determines whether or not to form the adjustment pattern again, and wherein, if it is determined that the adjustment pattern is to be formed again, then the liquid ejecting apparatus forms the adjustment pattern again in a position that differs from the predetermined position by ejecting liquid onto the medium.

Another aspect of the present invention is a computer-readable storage medium having recorded thereon a computer program for controlling a liquid ejecting apparatus that is capable of ejecting liquid onto a medium, the program causing the liquid ejecting apparatus to execute the steps of: forming an adjustment pattern in a predetermined position on the medium by ejecting liquid onto the medium; determining whether or not to form the adjustment pattern again; and if it is determined that the adjustment pattern is to be formed again, then forming the adjustment pattern again in a position that differs from the predetermined position by ejecting liquid onto the medium.

Another aspect of the present invention is a computer system comprising: a computer; and a liquid ejecting apparatus that is connected to the computer such that the liquid ejecting apparatus can establish wired or wireless communication with the computer, wherein the liquid ejecting apparatus is capable of forming an adjustment pattern in a predetermined position on a medium by ejecting liquid onto the medium, wherein, after forming the adjustment pattern, the liquid ejecting apparatus determines whether or not to form the adjustment pattern again, and wherein, if it is determined that the adjustment pattern is to be formed again, then the liquid ejecting apparatus forms the adjustment pattern again in a position that differs from the predetermined position by ejecting liquid onto the medium.

Overview of Liquid Ejecting Apparatus

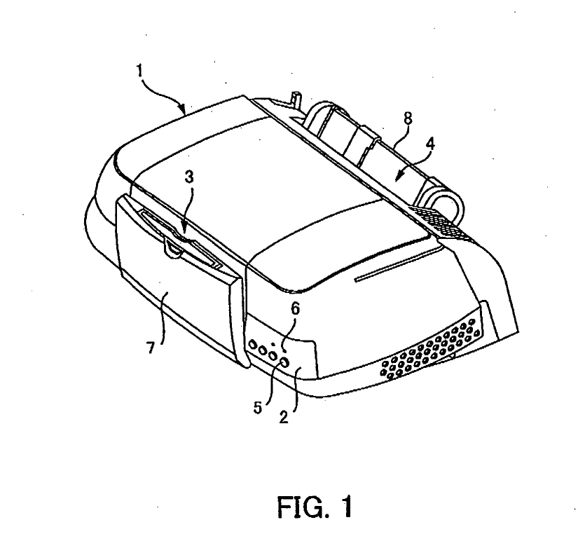

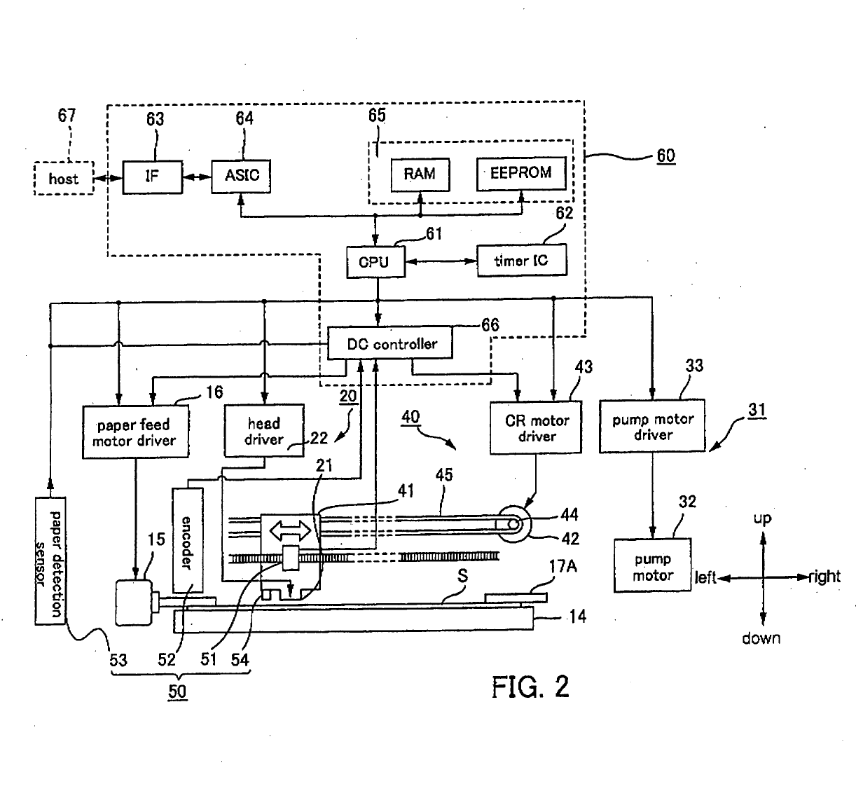

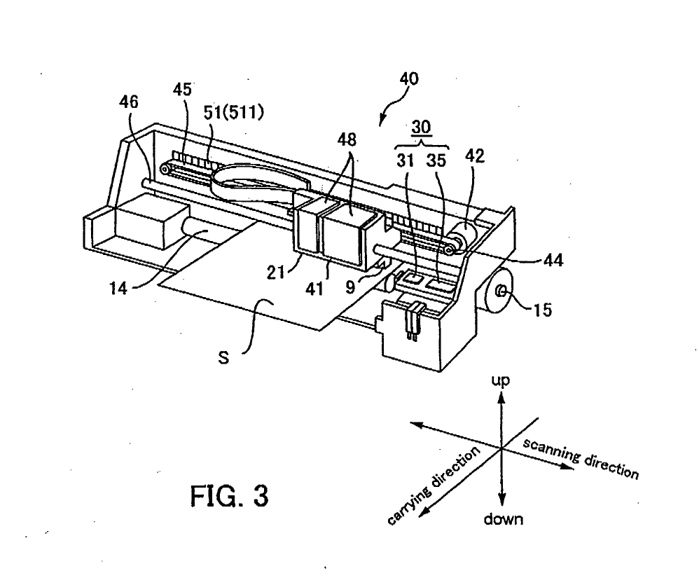

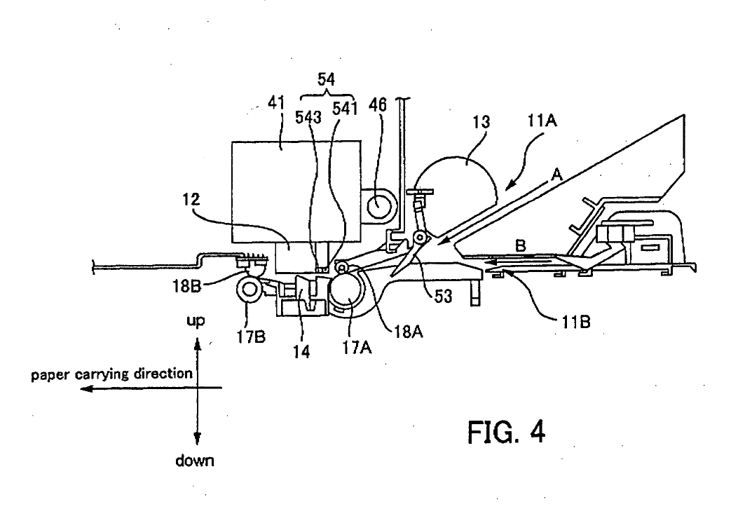

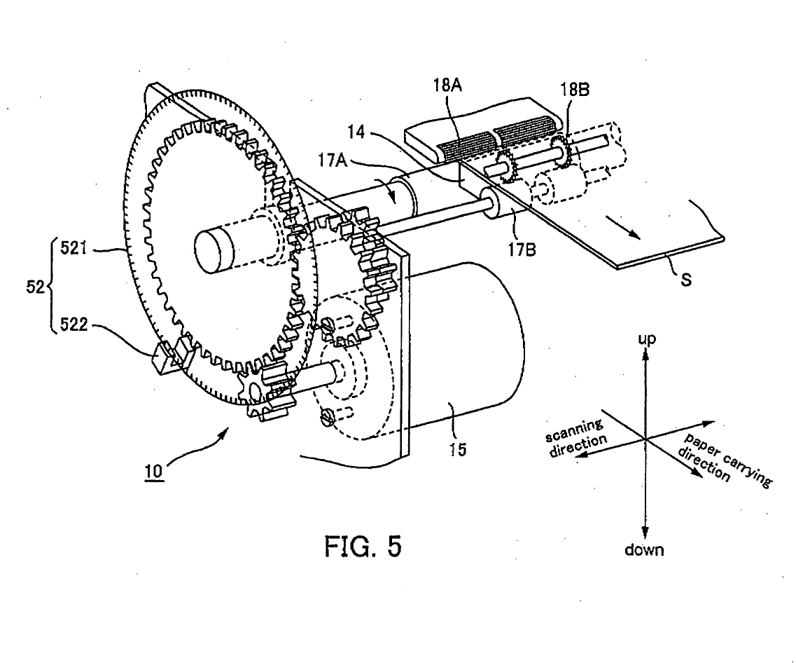

An overview of an inkjet printer serving as an example of a liquid ejecting apparatus according to the present invention is described below. FIG. 1 through FIG. 5 are figures for illustrating an overview of an embodiment of the inkjet printer. FIG. 1 shows an external view of an embodiment of the inkjet printer. FIG. 2 shows a block diagram of the inkjet printer. FIG. 3 shows a carriage and its periphery of the inkjet printer. FIG. 4 shows a carrying section and its periphery of the inkjet printer. FIG. 5 shows a drive mechanism of the carrying section of the inkjet printer.

As shown in FIG. 1, the inkjet printer 1 has a structure in which a medium to be printed, such as print paper, supplied from its rear face is discharged from its front face. The front face is provided with a control panel 2 and a paper discharge section 3. The rear face is provided with a paper supply section 4. The control panel 2 is provided with various operation buttons 5 and display lamps 6. Further, the paper discharge section 3 is provided with a paper discharge tray 7 that covers the paper discharge opening when the printer is not in use. The paper supply section 4 is provided with a paper supply tray 8 for holding cut paper (not shown in the figure). It should be noted that the inkjet printer 1 may be provided with a paper supply structure that enables printing not only on single-sheet print paper such as cut paper but also on continuous media to be printed such as roll paper.

As shown in FIG. 2, the inkjet printer 1 has, as its main parts, a paper carrying unit 10, an ink ejection unit 20, a cleaning unit 30, a carriage unit 40, a measuring instrument group 50, and a control unit 60.

The paper carrying unit 10 is for feeding a medium such as paper, which is an example of a medium to be printed, to a printable position and making the paper move in a predetermined direction (the direction perpendicular to the paper face in FIG. 2 (hereinafter, referred to as a paper carrying direction)) by a predetermined moving amount during printing. In other words, the paper carrying unit 10 functions as a carrying mechanism for carrying a medium such as paper. As shown in FIG. 4, the paper carrying unit 10 has a paper insert opening 11A, a roll paper insert opening 11B, a paper supply motor (not shown in the figure), a paper supply roller 13, a platen 14, a paper feed motor (hereinafter, referred to as PF motor) 15, a paper feed motor driver (hereinafter, referred to as PF motor driver) 16, a carry roller 17A, paper discharge rollers 17B, free rollers 18A, and free rollers 18B. The paper carrying unit 10, however, does not necessarily have to include all of these structural elements in order to function as a carrying mechanism.

The paper insert opening 11A is where paper S, which is an example of a medium, is inserted. The paper supply motor (not shown in the figure) is a motor for carrying the paper S that has been inserted into the paper insert opening 11A into the printer 1, and is constituted by a pulse motor. The paper supply roller 13 is a roller for automatically carrying into the printer 1 the paper that has been inserted into the paper insert opening 11A, and is driven by the paper supply motor 12. The transverse cross-sectional shape of the paper supply roller 13 is substantially the shape of the letter D. The peripheral length of the circumference of the paper supply roller 13 is set longer than the carrying distance to the PF motor 15, and therefore, using this circumference, the medium to be printed can be carried up to the PF motor 15. It should be noted that a plurality of sheets of media to be printed are kept from being supplied at one time by the rotational drive force of the paper supply roller 13 and the friction resistance of separating pads (not shown in the figure).

The platen 14 is a support means that supports the paper S during printing. As shown in FIG. 2, FIG. 4, and FIG. 5, the PF motor 15 is a motor for feeding a medium such as paper in the paper carrying direction, and is constituted by a DC motor. The PF motor driver 16 is for driving the PF motor 15. The carry roller 17A is a roller for feeding the paper S that has been carried into the printer by the paper supply roller 13 up to a printable region, and is driven by the PF motor 15. The free rollers 18A (see FIG. 4 and FIG. 5) are provided at positions that are in opposition to the carry roller 17A, and push the paper S toward the carry roller 17A by sandwiching the paper S between them and the carry roller 17A.

The paper discharge rollers 17B (see FIG. 4 and FIG. 5) are rollers for discharging the paper S for which printing has finished to the outside of the printer. The paper discharge rollers 17B are driven by the PF motor 15 through a gear wheel that is not shown in the figure. The free rollers 18B are provided at positions that are in opposition to the paper discharge rollers 17B, and push the paper S toward the paper discharge rollers 17B by sandwiching the paper S between them and the paper discharge rollers 17B.

The ink ejection unit 20 is for ejecting ink onto paper, which is an example of the medium to be printed. As shown in FIG. 2, the ink ejection unit 20 has a head 21 and a head driver 22. The head 21 has a plurality of nozzles, which are ink ejection sections, and ejects ink intermittently from each of the nozzles. The head driver 22 is for driving the head 21 so that ink is ejected intermittently from the head 21.

As also shown in FIG. 3, the cleaning unit 30 is for preventing the nozzles of the head 21 from becoming clogged. The cleaning unit 30 has a pump device 31 and a capping device 35. The pump device 31 is for sucking ink out from the nozzles in order to prevent the nozzles of the head 21 from becoming clogged, and has a pump motor 32 and a pump motor driver 33. The pump motor 32 sucks out ink from the nozzles of the head 21. The pump motor driver 33 drives the pump motor 32. The capping device 35 is for sealing the nozzles of the head 21 when printing is not being performed (during standby) so that the nozzles of the head 21 are kept from clogging.

As also shown in FIG. 3, the carriage unit 40 is for making the head 21 scan and move in a predetermined direction (in FIG. 2, the left and right directions of the paper face (hereinafter, this is referred to as the scanning direction)). The carriage unit 40 has a carriage 41, a carriage motor (hereinafter, referred to as CR motor) 42, a carriage motor driver (hereinafter, referred to as CR motor driver) 43, a pulley 44, a timing belt 45, and a guide rail 46. The carriage 41 can be moved in the scanning direction, and the head 21 is fastened to it. (Therefore, the nozzles of the head 21 intermittently eject ink as they are moved in the scanning direction.) The carriage 41 also removably holds ink cartridges 48 that accommodate ink. The CR motor 42 is a motor for moving the carriage 41 in the scanning direction, and is constituted by a DC motor. The CR motor driver 43 is for driving the CR motor 42. The pulley 44 is attached to a rotating shaft of the CR motor 42. The timing belt 45 is driven by the pulley 44. The guide rail 46 is for guiding the carriage 41 in the scanning direction.

The measuring instrument group 50 includes a linear encoder 51, a rotary encoder 52, a paper detection sensor 53, and a paper width sensor 54. The linear encoder 51 is for detecting the position of the carriage 41. The rotary encoder 52 is for detecting the amount of rotation of the carry roller 17A. It should be noted that the configuration, for example, of the encoders is described later. The paper detection sensor 53 is for detecting the position of the front end of the paper to be printed. The paper detection sensor 53 is provided in a position where it can detect the position of the front end of the paper as the paper is being carried toward the carry roller 17A by the paper supply roller 13. It should be noted that the paper detection sensor 53 is a mechanical sensor that detects the front end of the paper through a mechanical mechanism. More specifically, the paper detection sensor 53 has a lever that can be rotated in the paper carrying direction, and this lever is arranged so that it protrudes into the path over which the paper is carried. In this way, the front end of the paper comes into contact with the lever and the lever is rotated, and thus the paper detection sensor 53 detects the position of the front end of the paper by detecting the movement of the lever. The paper width sensor 54 is attached to the carriage 41. The paper width sensor 54 is an optical sensor having a light-emitting section 541 and a light-receiving section 543, and detects whether the paper exists or not in the position of the paper width sensor 54 by detecting light that is reflected by the paper. The paper width sensor 54 detects the position of the edge of the paper while being moved by the carriage 41, so as to detect the width of the paper. The paper width sensor 54 can also detect the front end of the paper according to the position of the carriage 41. The paper width sensor 54 is an optical sensor, and therefore, it can detect positions with higher precision than the paper detection sensor 53.

The control unit 60 is for carrying out control of the printer. The control unit 60 has a CPU 61, a timer 62, an interface section 63, an ASIC 64, a memory 65, and a DC controller 66. The CPU 61 is for carrying out the overall control of the printer, and sends control commands to the DC controller 66, the PF motor driver 16, the CR motor driver 43, the pump motor driver 32, and the head driver 22. The timer 62 periodically generates interrupt signals for the CPU 61. The interface section 63 exchanges data with a host computer 67 provided outside the printer. The ASIC 64 controls the printing resolution and the drive waveforms of the head, for example, based on print information sent from the host computer 67 through the interface section 63. The memory 65 is for reserving an area for storing the programs for the ASIC 64 and the CPU 61 and a working area, for instance, and has storage means such as a RAM or an EEPROM. The DC controller 66 controls the PF motor driver 16 and the CR motor driver 43 based on control commands sent from the CPU 61 and the output from the measuring instrument group 50.

During printing, the paper S is intermittently carried by the carry roller 17A by a predetermined carry amount, and between each intermittent carry, the carriage 41 moves in a direction perpendicular to the carrying direction of the carry roller 17A and the head 21 ejects ink onto the paper S. Printing is carried out in this way.

Ejection Mechanism of the Head 21

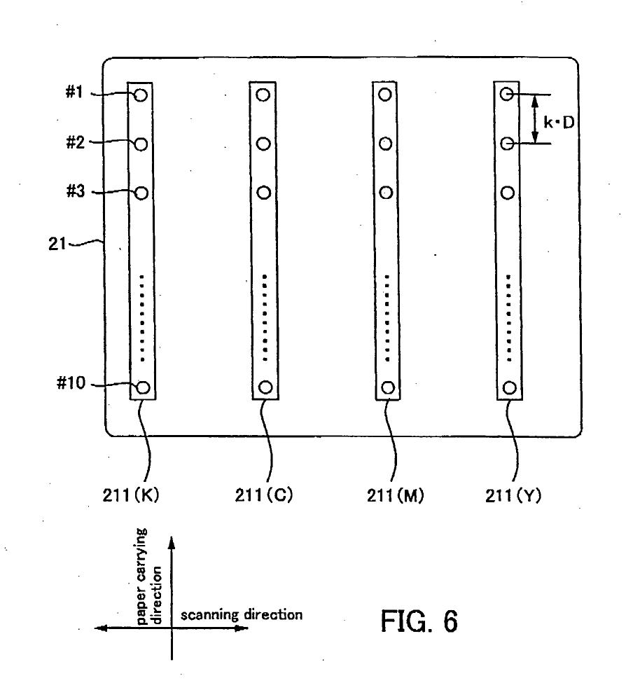

FIG. 6 is a diagram showing an arrangement of ink ejection nozzles provided in the bottom face of the head 21. As shown in the figure, the bottom face of the head 21 is provided with nozzle arrays 211 for each color of black (K), cyan (C), magenta (M), and yellow (Y). The nozzle array for each color is made up of a plurality of nozzles #1 through #10. The nozzles #1 through #10 are arranged in a line in the carrying direction of the paper S. Each nozzle array 211 is arranged parallel to the other nozzle arrays and is spaced apart from the other nozzle arrays in the moving direction (scanning direction) of the head 21. Each nozzle #1 through #10 is provided with a piezoelectric element (not shown in the figure) as a driving element for ejecting ink droplets.

The piezoelectric element is a device whose crystal structure deforms when voltage is applied thereto and that is for converting electric energy into mechanical energy at an extremely high speed. When voltage of a predetermined time width is applied between electrodes provided on both ends of the piezoelectric element, the element expands according to the time for which the voltage is applied, and it deforms the side wall of the passage through which the ink flows. In this way, the volume of the passage through which the ink flows is made to decrease due to the expansion of the piezoelectric element, and ink equal to the amount of decrease in volume is ejected, as ink droplets, from each of the nozzles #1 through #10 for each color.

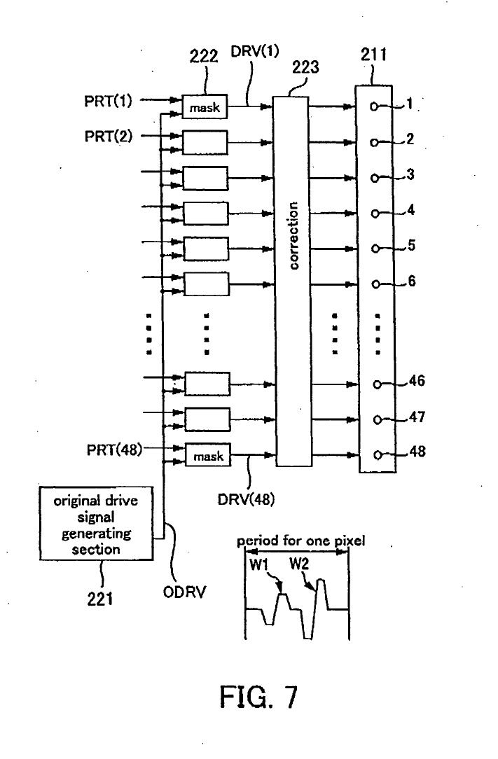

FIG. 7 shows a drive circuit for the nozzles #1 through #10. As shown in the figure, the drive circuit includes an original drive signal generating section 221, a plurality of mask circuits 222, and a drive signal correction circuit 223. The original drive signal generating section 221 generates original signals ODRV that are used in common among the nozzles #1 through #n. The original signal ODRV is a signal that includes two pulses—a first pulse Wl and a second pulse W2—during the main scan period for one pixel (during the time in which the carriage 41 passes across a distance for one pixel), as shown in the lower section of the figure. The original signal ODRV that has been generated by the original drive signal generating section 221 is output to each of the mask circuits 222.

The mask circuit 222 is provided for each of the plurality of piezoelectric elements that drives each of the nozzles #1 through #n of the head 21. The original signal ODRV is input from the original drive signal generating section 221 to each mask circuit 222, and also, print signals PRT(i) are input to each mask circuit 222. The print signal PRT(i) is pixel data corresponding to each pixel and is a binary signal containing two-bit information for one pixel. The mask circuit 222 either blocks the original signal ODRV from passing through or lets the original signal ODRV pass through according to the level of the print signal PRT(i). More specifically, when the level of the print signal PRT(i) is “0”, then the pulse of the original signal ODRV is blocked, whereas when the level of the print signal PRT(i) is “1”, then the mask circuit 222 lets the pulse corresponding to the original signal ODRV pass right through and outputs it to the drive signal correction circuit 223 as a drive signal DRV.

The drive signal correction circuit 223 corrects the drive signals DRV from the mask circuits 222 and outputs the corrected signals to each piezoelectric element of each nozzle #1 through #10. The “correction” performed here is described in detail later. The piezoelectric element of each nozzle #1 through #10 activates based on the drive signal DRV from the drive signal correction circuit 223 for ink ejection.

Adjustment Pattern

The inkjet printer according to the present embodiment has a function of printing a predetermined adjustment pattern on a medium such as paper S in order to perform various kinds of adjustments. Adjustments that are carried out with this function are described below.

<Bi-d Adjustment>

Bi-d adjustment (bi-directional adjustment) is an adjustment for making the ink landing position during the forward pass and the ink landing position during the return pass match for cases in which printing is carried out on a medium S by ejecting ink during both the forward pass and the return pass while making the head 21 move back and forth relatively with respect to the medium, as with the printer 1 of the present embodiment.

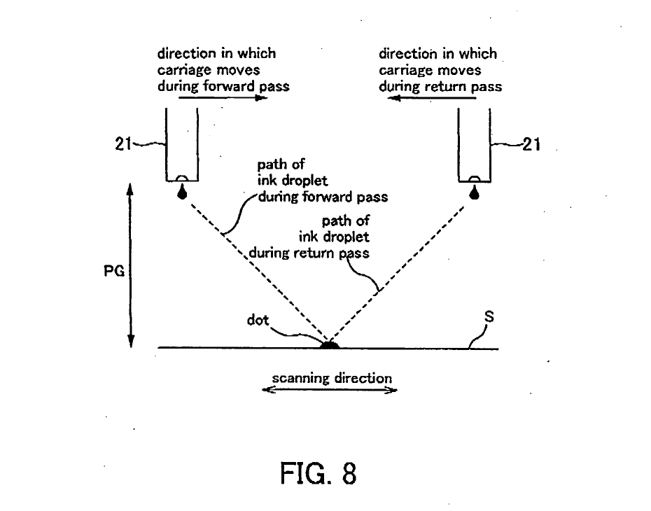

FIG. 8 is a diagram for illustrating ink ejecting timings during the forward pass and the return pass of the head 21. This explanatory diagram is viewed from the carrying direction, and therefore, the direction perpendicular to the paper face is the carrying direction and the left and right direction of the paper face is the scanning direction. The head 21 and the paper S are arranged in opposition with each other with a gap PG provided therebetween. The ink droplet Ip ejected from the head 21 moves the distance of the gap PG and reaches the paper S. Since the ink droplet Ip is ejected while the carriage 41 is being moved, the droplet is subjected to inertial force. Therefore, in order to form a dot in a target position on the print paper S, it is necessary to eject ink from a position before the target position. Since the moving direction of the carriage 41 is opposite for the forward pass and the return pass, the timing for ejecting ink differs even when a dot is to be formed in the same target position. In view of the above, in order to adjust the ink ejection timings for the forward pass and the return pass, a predetermined adjustment pattern is printed so that the user can confirm the timing.

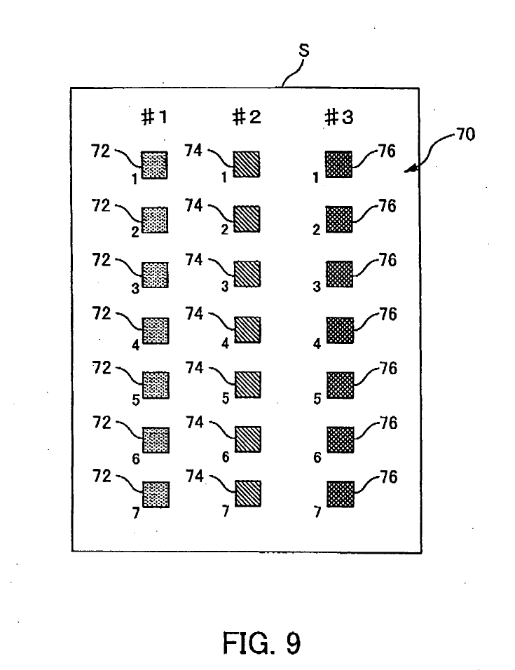

FIG. 9 shows an embodiment of a Bi-d adjustment pattern that is printed in this example. The adjustment pattern 70 is made up of a plurality of patches 72, 74, and 76 that are arranged in lines in the length direction of the paper face, and three rows of these patches are formed spaced from each other in the width direction of the paper face. The patches 72 in the row in the left of the paper face are patches for the “fine mode” (#1). The patches 74 in the row in the center of the paper face are patches for the “high resolution mode” (#2). The patches 76 in the row in the right of the paper face are patches for the “super-high resolution mode” (#3). Each of the patches 72, 74, and 76 in each row is formed one by one in the length direction of the paper face by shifting the ink ejection timing for the forward pass and the ink ejection timing for the return pass of the head 21. That is, each of the patches 72, 74, and 76 in each row is formed by gradually shifting, for each patch, the ink ejection timing for the forward pass and the ink ejection timing for the return pass of the head 21 using the drive signal correction circuit 223 of FIG. 7 described above. A patch number (“1” through “7”) is assigned to each of the patches 72, 74, and 76 in each row as a reference character for individually specifying each of the patches 72, 74, and 76.

It should be noted that in the present embodiment, the procedure for printing each of the patches 72, 74, and 76 for the “fine mode” (#1), the “high resolution mode” (#2), and the “super-high resolution mode” (#3) is as follows. First, the patches 72 for the “fine mode” (#1) are printed on the medium S that has been set to the paper supply section 4. Then, the medium S is once discharged, the discharged medium S is again set to the paper supply section 4, and the patches 74 for the “high resolution mode” (#2) are printed on the medium. Then, the medium S is again discharged, the discharged medium S is again re-set to the paper supply section 4, and the patches 76 for the “super-high resolution mode” (#3) are printed.

The user looks at the patches 72, 74, and 76 that have been printed on the medium, and confirms the printing state of each patch, such as whether the printed patch is rough or smooth. The user then selects, for example, the patch that seems least rough (i.e., smoothest) for each mode, that is, for each row of the “fine mode” (#1), the “high resolution mode” (#2), and the “super-high resolution mode” (#3). The printer 1 stores the adjustment information obtained based on the patch number selected by the user in an appropriate storage section such as a nonvolatile memory, and reflects the information in further printing processes.

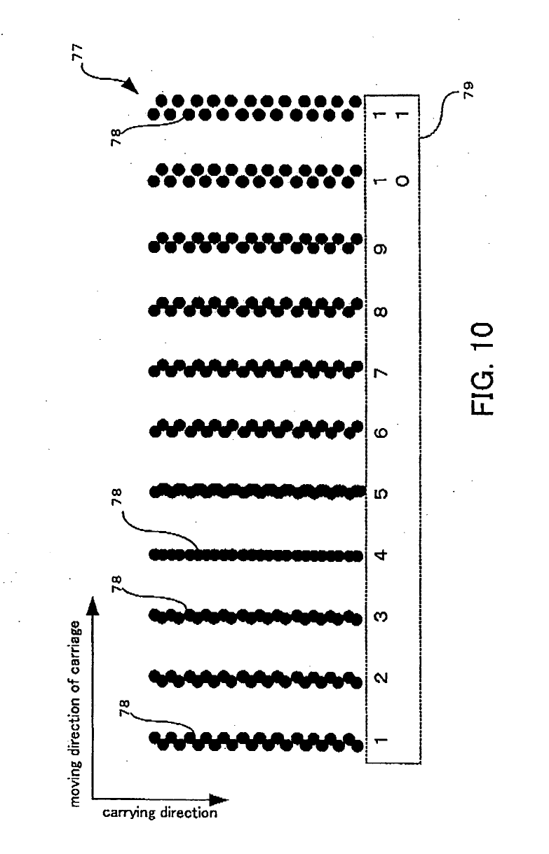

Other than the above, a pattern as shown in FIG. 10 in which a plurality of lengthwise lines 78 are formed spaced from each other in the width direction of the paper face may be adopted as the Bi-d adjustment pattern. This pattern 77 is formed by gradually shifting the ink ejection timing for the forward pass and the ink ejection timing for the return pass of the head 21 for each line 78 sequentially from the left. A reference character 79 (“1” through “15”) is assigned to each line 78 for individually specifying each line. The user carries out adjustment by looking at each line 78 that has been printed on the medium and selecting the sharpest and finest line 78.

It should be noted that the Bi-d adjustment pattern is not limited to the above-mentioned two patterns, and any other kind of pattern may be adopted.

<Paper Feed Adjustment>

Paper feed adjustment is an adjustment for canceling carry errors of the medium S by the carry roller 17A. One main cause of carry errors is the manufacture error of the carry roller 17A. Manufacture error occurs because the actual outside diameter of the carry roller 17A differs from the design value and because the design error range of the carry roller 17A is set slightly large in order to improve manufacturing yield, for example. The above-mentioned paper feed adjustment is carried out mainly after the product is finished and before the product is shipped.

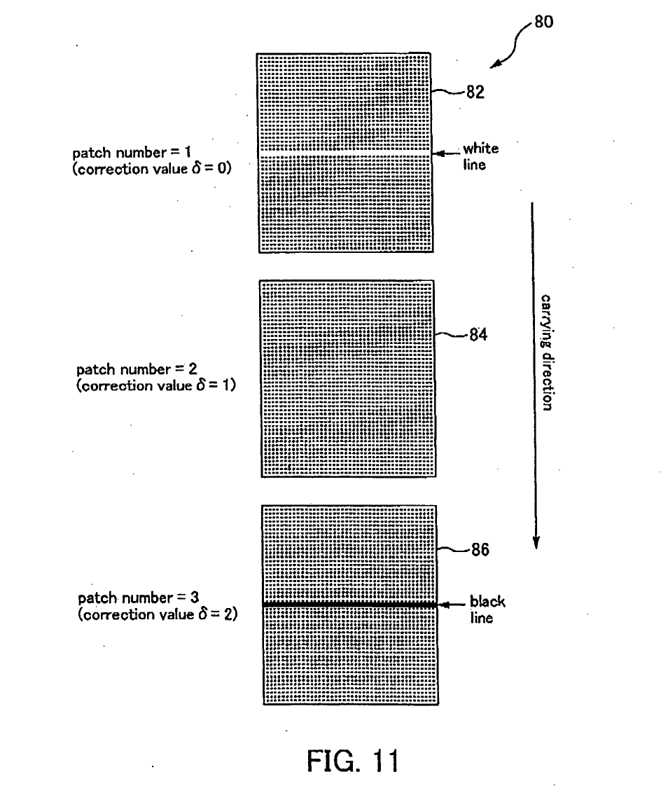

FIG. 11 shows an embodiment of a paper feed adjustment pattern. The adjustment pattern 80 is made up of three patches 82, 84, and 86 each having a different paper feed adjustment amount δ. A patch number (“1” through “3”) is assigned to each patch 82, 84, and 86 on the left side thereof as a reference character for individually specifying each patch 82, 84, and 86. The three patches 82, 84, and 86 are compared below. As regards the patch 82 with patch number “1” (the upper patch in the figure), a white line can be seen. This white line appears because the outside diameter of the carry roller 17A is larger than the design value and the actual carry amount is larger than the target carry amount. On the other hand, as regards the patch 86 with patch number “3” (the lower patch in the figure), a black line can be seen. This black line appears because the outside diameter of the carry roller 17A is smaller than the design value and the actual carry amount is smaller than the target carry amount. The patch 84 with patch number “2” (the patch in the center of the figure) does not have a white line nor a black line. In other words, as for the patch 84 with patch number “2”, the size of the outside diameter of the carry roller 17A is within the tolerance range.

During-inspection after finishing the product, an inspector, for example, looks at the patches 82, 84, and 86 and confirms the printing state of each patch, such as whether the printed patch is rough or smooth. Then, he/she selects the most suitable patch from the patches 82, 84, and 86. In the present example, the patch 84 with patch number “2” is selected as the suitable patch. The printer 1 stores the adjustment information obtained based on the selected patch number in an appropriate storage section such as a nonvolatile memory, and reflects the information in further printing.

It should be noted that the paper feed adjustment pattern is not limited to the above-mentioned pattern form, and any other kind of pattern may be adopted.

Further, the adjustment pattern of the present invention is not limited to the Bi-d adjustment pattern and the paper feed adjustment pattern described above, and any other kind of adjustment pattern, such as a head position adjustment pattern for adjusting the position of the head 21, may be adopted.

Printing the Adjustment Pattern Again

The inkjet printer of the present embodiment has a function of re-printing an adjustment pattern for readjustment after adjustment such as selection of a patch has been carried out once. This function will be described in detail below.

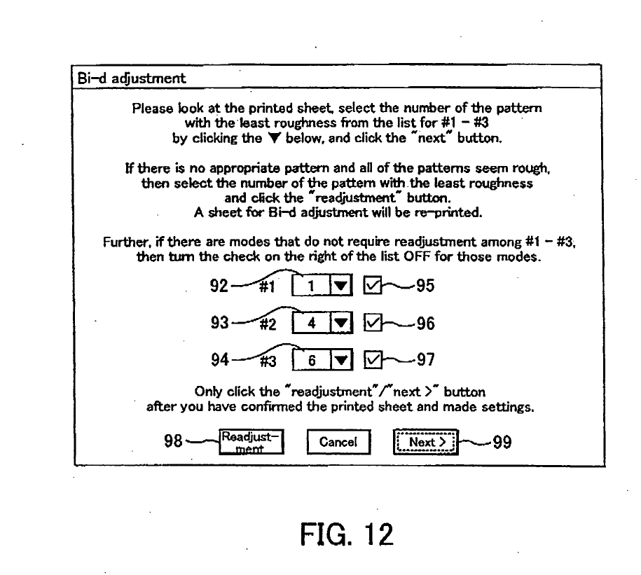

FIG. 12 shows an example of a setting screen through which a user carries out adjustment based on the printed adjustment pattern and makes readjustment settings. Here, an example in which a Bi-d adjustment pattern such as the one shown in FIG. 9 is printed for performing readjustment is described. It should be noted that the setting screen is displayed, for example, on a display section such as a display provided on the printer 1 or a display of the host computer 67 connected to the printer 1.

The user looks at the setting screen that has been displayed and enters, into predetermined input boxes 92, 93, and 94 provided on the setting screen, the number of the patch selected for each mode, that is, for each of the “fine mode” (#1), the “high resolution mode” (#2), and the “super-high resolution mode” (#3) in the present example. More specifically, for example, if the user selects patch number “1” from the patches of the “fine mode” (#1), then the user enters “1” in the input box 92 corresponding to “#1”. Further, if the user selects patch number “4” from the patches of the “high resolution mode” (#2), then the user enters “4” in the input box 93 corresponding to “#2”, and if the user selects patch number “6” from the patches of the “super-high resolution model” (#3), then the user enters “6” in the input box 94 corresponding to “#3”.

Further, if readjustment is to be made, each check box 95, 96, and 97 that is provided on the right of each input box corresponding to the mode for which readjustment is to be made is checked. It should be noted that in the present example, all of the check boxes 95, 96, and 97 are automatically checked by default, and the checks are turned off for the modes that do not need readjustment. Then, by clicking the “readjustment” button 98 or the “next” button 99 on the bottom of the setting screen, the adjustment pattern 70 for the modes for which the corresponding check boxes 95, 96, and 97 have been checked is again printed.

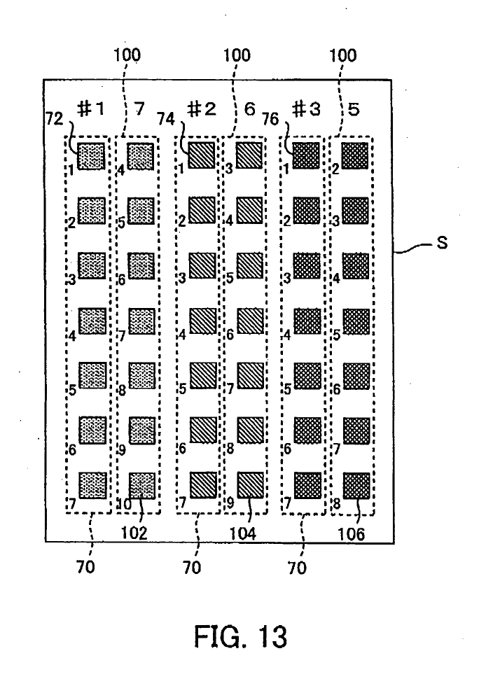

FIG. 13 shows an embodiment of an adjustment pattern (referred to also as a “readjustment pattern” below) 100 that is printed again (re-printed). The readjustment pattern 100 is automatically printed in a position that differs from the printing position of the adjustment pattern 70 that has been printed earlier. That is, the readjustment pattern 100 is automatically printed in such a manner that it does not superpose on the adjustment pattern 70 that has been printed earlier. In the present example, the readjustment pattern 100 is printed on the right of and corresponding to each row of the already-printed adjustment pattern 70.

By forming the readjustment pattern 100 in a position that differs from the position of the adjustment pattern 70 that has been printed earlier, it is possible to print the readjustment pattern 100 on the medium S on which the adjustment pattern 70 has been printed, and in this way, it is possible to use the medium S, on which the adjustment pattern 70 has already been printed, for printing the readjustment pattern 100. That is, it is possible to reduce the number of media S that is used in printing the adjustment pattern 70.

In this example, the readjustment pattern 100 is made up of a plurality of patches 102, 104, and 106 that are arranged in lines in the length direction of the paper face and that are provided for each mode, that is, the “fine mode” (#1), the “high resolution mode” (#2), and the “super-high resolution mode” (#3), as with the adjustment pattern 70. A reference character for specifying each patch 102, 104, and 106 is assigned to each patch 102, 104, and 106 for each mode, as with the adjustment pattern 70. In each mode (“#1” through “#3”), the patches are arranged so that the patch corresponding to the patch number that has been selected through the setting screen shown in FIG. 12 comes in the center, and that patch is positioned in the center of the row.

More specifically, for example, if patch number “7” is selected for the “fine mode” (#1), then the row of patches is arranged so that the patch corresponding to patch number “7” comes in the central section of the row. Further, if patch number “6”, is selected for the “high resolution mode” (#2), then the row of patches is arranged so that the patch corresponding to patch number “6” comes in the central section of the row. Furthermore, if patch number “5” is selected from the patches of the “super-high resolution mode” (#3), then the row of patches is arranged so that the patch corresponding to patch number “5” comes in the central section of the row. The patch number that has been selected for each mode for readjustment (“7” for the fine mode, “6” for the high resolution mode, and “5” for the super-high resolution mode) is printed above each row in the readjustment pattern 100.

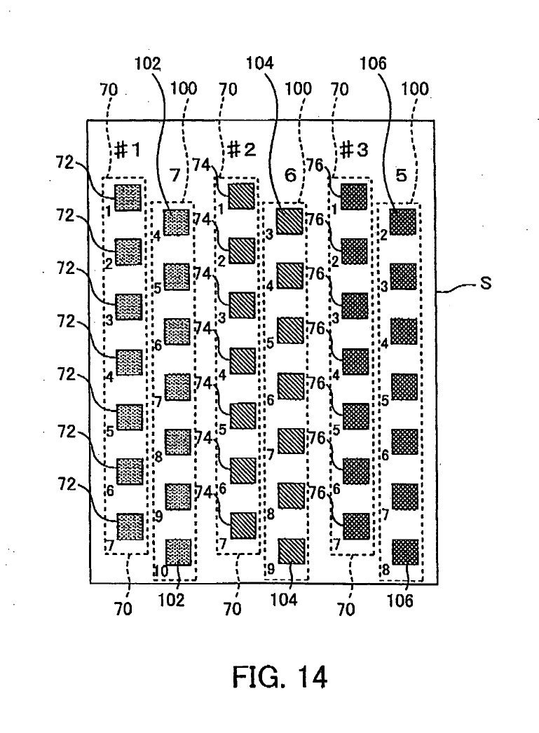

FIG. 14 shows another example of a printed readjustment pattern 100. In this example, the patches 102, 104, and 106 in each row that have been printed as the readjustment pattern 100 are formed such that the positions in which they are formed are shifted diagonally downwards with respect to the positions of the patches 72, 74, and 76 in each row of the adjustment pattern 70 that has been printed earlier. By printing the readjustment pattern 100 so that its horizontal position is shifted with respect to the adjustment pattern 70 that has been printed earlier, it is possible to distinguish the readjustment pattern 100 from the adjustment pattern 70 easily.

As described above, according to the present inkjet printer, the readjustment pattern 100 for performing readjustment after various adjustments have been made is printed in a position that differs from the position of the adjustment pattern 70 that has been already printed on the medium earlier. Therefore, it is possible to use the medium S, on which the adjustment pattern 70 has already been printed, for printing the readjustment pattern 100, and accordingly, it is possible to reduce the number of media S that is used for printing.

It should be noted that in the above, an example in which readjustment is made once by printing the readjustment pattern 100 was described. The present invention, however, is not limited to this, and it is possible to make readjustment twice, or even more, by printing the readjustment pattern 100 again. In this case, the readjustment pattern 100 is to be automatically printed in a position that differs from both the position in which the adjustment pattern 70 has been printed earlier and the position in which the readjustment pattern 100 has been printed, every time readjustment is to be made.

Further, as regards the position in which the readjustment pattern 100 is to be printed, a plurality of printing positions to choose from may be provided when printing of the readjustment pattern 100 is performed, and the user may appropriately select a printing position from those plurality of potential printing positions.

Computer Program

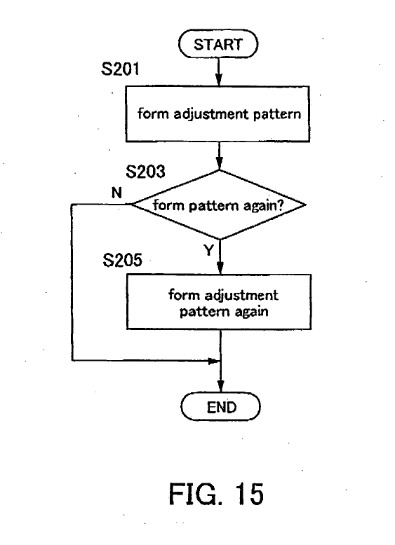

A computer program for controlling a liquid ejecting apparatus according to the present invention will be described below, taking the above-described inkjet printer as an example. FIG. 15 is a diagram showing some main processes of a processing procedure of the computer program for controlling the inkjet printer.

As shown in FIG. 15, the method of forming an adjustment pattern with the inkjet printer that is capable of ejecting liquid onto a medium according to the present embodiment includes the following steps:

a step of forming an adjustment pattern in a predetermined position on the medium by ejecting liquid onto the medium (S201);

a step of determining whether or not to form the adjustment pattern again (S203); and

if it is determined that the adjustment pattern is to be formed again, a step of forming the adjustment pattern again in a position that differs from the predetermined position by ejecting liquid onto the medium (S205).

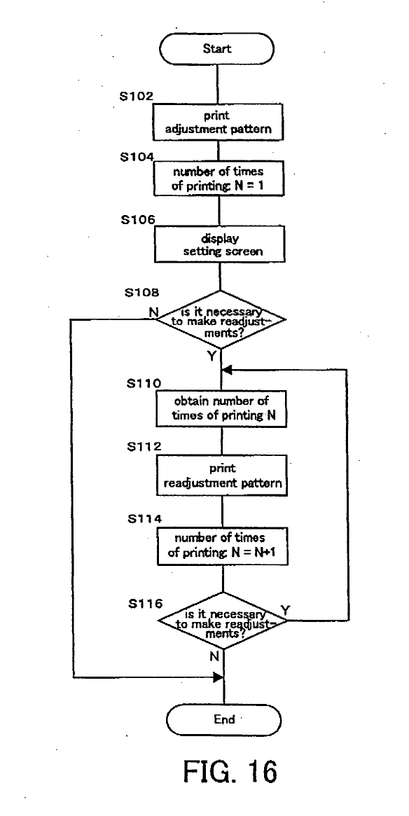

FIG. 16 is a flowchart showing a more detailed example of the processing procedure of the computer program for controlling the inkjet printer.

In this example, when there is an adjustment request from the user, an adjustment pattern 70 is printed in a predetermined position in response to the request (S102). Further, in performing printing, the number of times of printing N is initialized and set to “1” in order to count the number of times of printing, and this number is stored (S104). In printing the adjustment pattern 70, it should be noted that, as described above, first, the patches 72 for the “fine mode” (#1) are printed on the medium S that has been set to the paper supply section 4. Then, the medium S is once discharged, the discharged medium S is again set to the paper supply section 4 by the user, and the patches 74 for the “high resolution mode” (#2) are printed. Then, the medium S is again discharged, the discharged medium S is again re-set to the paper supply section 4, and the patches 76 for the “super-high resolution mode” (#3) are printed. Then, a setting screen, such as the one shown in FIG. 12, is displayed in order for the user to enter the adjustment information (S106).

After the user finishes entering the settings, the apparatus checks whether or not the user made a request for readjustment (S108). This step is the step of determining whether or not to form the adjustment pattern again.

If there is no request for readjustment at this time, the process ends here.

On the other hand, if there is a request for readjustment from the user, that is, if it is determined that the adjustment pattern is to be formed again, then the process advances to step S110, and the number of times of printing N is obtained.

Next, based on the value of the number of times of printing N that has been obtained, the readjustment pattern 100 is printed in a position that differs from the position in which the adjustment pattern 70 has already been printed so that the readjustment pattern 100 does not superpose on the adjustment pattern 70 that has been printed earlier (S112). More specifically, for example, if the number of times of printing N is “1”, then it can be determined that only the adjustment pattern 70 has been printed on the medium S. In this way, it is possible to print the readjustment pattern 100 in a position other than the predetermined position in which the adjustment pattern 70 has been printed. The readjustment pattern 100 is printed in a predetermined position that is set in advance.

It should be noted that the procedure for printing the readjustment pattern 100 is also as follows. First, the patches 102 for the “fine mode” (#1) are printed on the medium S that has been set to the paper supply section 4. Then, the medium S is once discharged, the discharged medium S is again set to the paper supply section 4, and the patches 104 for the “high resolution mode” (#2) are printed. Then, the medium S is again discharged, the discharged medium S is again re-set to the paper supply section 4, and the patches 106 for the “super-high resolution mode” (#3) are printed.

After finishing printing the readjustment pattern 100, the apparatus checks whether or not the user made a request for readjustment. If there is no request for readjustment, the process ends here. On the other hand, if there is a request for readjustment, then the process returns to step Si 10, and the number of times of printing N is obtained again. Then, based on the number of times of printing N that has been obtained, the readjustment pattern 100 is printed so that it does not superpose on the adjustment pattern 70 and the readjustment pattern 100 that have been printed earlier (S112). More specifically, for example, if the number of times of printing N is “3”, then the printing positions of the adjustment pattern 70 and the two readjustment patterns 100 that have been printed earlier can be determined. In this way, it is possible to again print the readjustment pattern 100 so that it does not superpose on the other patterns.

In the example above, the number of times of printing N was stored, and the printing position of the already-printed adjustment pattern 70 or the readjustment pattern 100 was specified based on the number of times of printing N. It should be noted that the present invention, however, is not limited to this, and the printing position of the adjustment pattern 70 or the readjustment pattern 100 may be directly stored as data, for example.

Further, in the example above, printing of the readjustment pattern 100 was carried out continuously until there are no more requests from the user. Such a process, however, does not necessarily have to be carried out, and the number of times of printing may be set in beforehand in the computer program or the number of times of printing may be limited in some way.

Further, the computer program is not limited to one that is executed by a liquid ejecting apparatus such as an inkjet printer. For example, the program may be executed by external computers such as the host computer 67, and the liquid ejecting apparatus may be controlled from outside.

Configuration of Computer System Etc.

Next, an embodiment of a computer system according to the present invention is described with reference to the drawings.

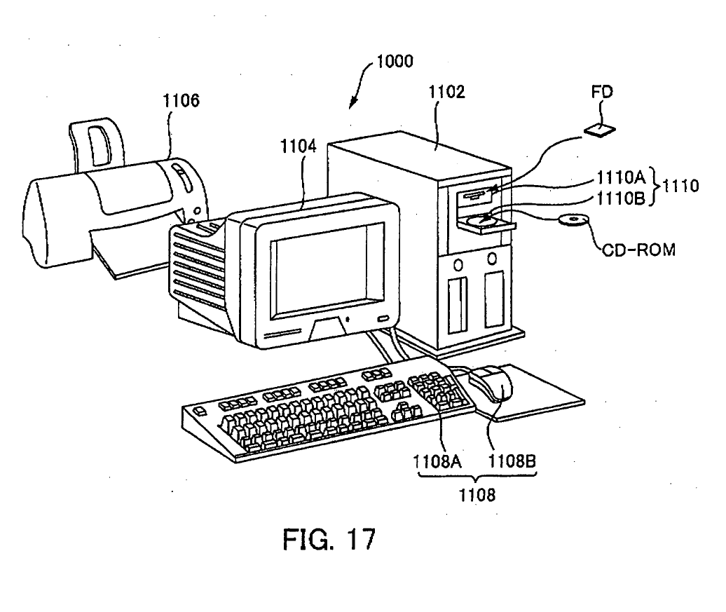

FIG. 17 is an explanatory diagram showing an external configuration of a computer system. The computer system 1000 includes a computer unit 1102, a display device 1104, a printer 1106, an input device 1108, and a reading device 1110. In the present embodiment, the computer unit 1102 is housed in a mini-tower casing; however the structure is not limited to this. Although a CRT (cathode ray tube), a plasma display, or a liquid crystal display device is generally used as the display device 1104, any other kind of device can be used. The printer described above is used as the printer 1106. In the present embodiment, a keyboard 1108A and a mouse 1108B are used as the input device 1108; however, any other kind of device can be used. In the present embodiment, a flexible disk drive device 1110A and a CD-ROM drive device 1110B are used as the reading device 1110; this, however, is not a limitation, and it is also possible-to use an MO (magneto optical) disk drive device, a DVD (digital versatile disk) drive, or any other kind of device.

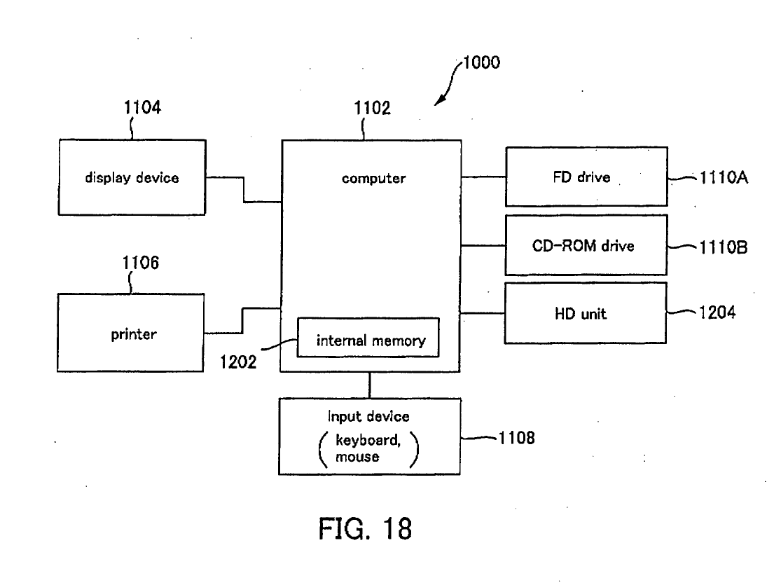

FIG. 18 is a block diagram showing the configuration of the computer system shown in FIG. 17. FIG. 18 shows that an internal memory 1202, such as a RAM, provided inside the casing in which the computer unit 1102 is housed, and an external memory, such as a-hard-disk drive unit 1204, are also provided.

The computer program for controlling the above-mentioned operations of the printer may be downloaded to, for example, the computer 1000 connected to the printer 1106 via a communications line such as the Internet. It is also possible, for example, to record the program on a computer-readable storage medium and distribute it in this form. It is possible to use various kinds of storage media such as flexible disks FDs, CD-ROMs, DVD-ROMs, magneto-optical disks MOs, hard disks, and memories, as the storage medium. It should be noted that the information recorded on such a storage medium can be read by various kinds of reading devices 1110.

It should be noted that in the description above, an example in which the printer 1106 is connected to the computer unit 1102, the display device 1104, the input device 1108, and the reading device 1110 to configure the computer system was described. The configuration, however, is not limited to the above. For example, the computer system may be configured comprising only the computer unit 1102 and the printer 1106, and it does not have to comprise any one of the display device 1104, the input device 1108, or the reading device 1110. Further, for example, it is also possible for the printer 1106 to have some of the functions or mechanisms of each of the computer unit 1102, the display device 1104, the input devices 1108, and the reading device 1110. For example, it is possible to structure the printer 1106 so that it comprises an image processor for processing images, a display section for performing various kinds of displaying, and a recording media mounting section for detachably mounting a recording medium on which image data captured with a digital camera or the like is stored.

Further, in the foregoing embodiment, the computer program for controlling the printer may be taken into the memory 65, which is a storage medium of the control unit 60. The operations of the printer of the foregoing embodiment may then be achieved by making the control unit 60 execute the computer program stored in the memory 65.

A computer system configured as above will be superior to existing computer systems as a whole.

Other Embodiments

A liquid ejecting apparatus, such as a printer, according to the present invention was described above based on an embodiment thereof. The foregoing embodiment of the invention, however, is for facilitating understanding of the present invention and is not to limit the present invention. The present invention may be modified and/or altered without departing from the gist thereof, and it is needless to say that the present invention includes its equivalents. Particularly, even the embodiments described below are included in the printing apparatus according to the present invention.

Further, in the present embodiment, some or all of the structures realized by hardware may instead be achieved by software, and conversely, some of the configurations achieved by software may be achieved by hardware.

Further, other than print paper, the medium to be printed may be, for example, cloth or film.

Furthermore, some of the processes carried out on the printing apparatus side may be carried out by the host computer. It is also possible to provide a dedicated processing device between the printing apparatus and the host computer and make this dedicated processing device carry out some of the processes.

<About the Liquid Ejecting Apparatus>

The liquid ejecting apparatus of the present invention is applicable not only to printing apparatuses such as the inkjet printer described above, but also applicable to, for example, color filter manufacturing devices, dyeing devices, fine processing devices, semiconductor manufacturing devices, surface processing devices, three-dimensional shape forming machines, liquid vaporizing devices, organic EL manufacturing devices (particularly macromolecular EL manufacturing devices), display manufacturing devices, film formation devices, or DNA chip manufacturing devices. When the present invention is applied to such fields, savings in costs compared to conventional cases can be achieved.

<About the Medium>

The medium may be paper as described above, such as plain paper, matte paper, cut paper, glossy paper, roll paper, paper sheets, photographic paper, and rolled-type photographic paper. Other than the above, films such as OHP films and glossy films, cloths, or metal sheets, for example, may be used as the medium. That is, any kind of medium can be used as long as it may be a target of liquid ejection.

<About the Liquid>

The liquid of the present invention is not limited to inks such as dye ink and pigment ink described above. For example, it is also possible to suitably use liquid (including water) such as metallic materials, organic materials (in particular polymeric materials), magnetic materials, conductive materials, wiring materials, film forming materials, electronic ink, machining liquids, genetic solutions, and so forth.

What is claimed is:

1. A method for ejecting liquid comprising the steps of:
forming an adjustment pattern in a predetermined position on a medium by ejecting liquid onto said medium;
determining whether or not to form said adjustment pattern again; and
if it is determined that said adjustment pattern is to be formed again, then forming said adjustment pattern again in a position that differs from said predetermined position by ejecting liquid onto said medium.

2. A method for ejecting liquid according to claim 1, wherein:
if an additional adjustment pattern is to be formed on said medium after forming said adjustment pattern again,
then said additional adjustment pattern is formed in a position that differs from both the position in which said adjustment pattern has been formed earlier and the position in which said adjustment pattern has been formed again.

3. A method for ejecting liquid according to claim 1, wherein:
said adjustment pattern is formed in a plurality of locations on said medium; and
adjustment patterns are formed again in correspondence with each of the adjustment patterns that have been formed earlier in said plurality of locations.

4. A method for ejecting liquid according to claim 1, wherein:
at least either one of said adjustment pattern formed earlier on said medium or said adjustment pattern formed again on said medium is marked in the vicinity thereof with a character for specifying that it is the adjustment pattern formed earlier or a character for specifying that it is the adjustment pattern formed again.

5. A method for ejecting liquid according to claim 1, wherein:
said adjustment pattern that is formed again is formed side by side with said adjustment pattern that has been formed earlier.

6. A method for ejecting liquid according to claim 1, wherein:
said adjustment pattern that is formed again is formed diagonally adjacent to said adjustment pattern that has been formed earlier.

7. A method for ejecting liquid according to claim 1, wherein:
said adjustment pattern formed earlier and said adjustment pattern formed again are formed by an ejection head that is for ejecting liquid while moving relatively with respect to said medium; and
said adjustment pattern that has been formed earlier and said adjustment pattern that has been formed again are patterns for adjusting a misalignment between
a position on said medium where said liquid reaches when said ejection head moves in one direction, and
a position on said medium where said liquid reaches when said ejection head moves in another direction.

8. A method for ejecting liquid according to claim 1, wherein:
said adjustment pattern that has been formed earlier and said adjustment pattern that has been formed again are patterns for adjusting a carry amount for which said medium is carried.

9. A method for ejecting liquid according to claim 1, further comprising a step of:
setting the position in which said adjustment pattern is to be formed again.

10. A method for ejecting liquid according to claim 1, wherein:
said liquid is ink; and
said adjustment pattern formed earlier and said adjustment pattern formed again are printed by ejecting said ink onto said medium.

11. A liquid ejecting apparatus comprising:
a liquid ejecting section for ejecting liquid onto a medium,
wherein said liquid ejecting apparatus is capable of forming an adjustment pattern in a predetermined position on said medium with said liquid ejecting section,
wherein, after forming said adjustment pattern, said liquid ejecting apparatus determines whether or not to form said adjustment pattern again, and
wherein, if it is determined that said adjustment pattern is to be formed again, then said liquid ejecting apparatus forms said adjustment pattern again in a position that differs from said predetermined position by ejecting liquid onto said medium.

12. A computer-readable storage medium having recorded thereon a computer program for controlling a liquid ejecting apparatus that is capable of ejecting liquid onto a medium, said program causing said liquid ejecting apparatus to execute the steps of:
forming an adjustment pattern in a predetermined position on said medium by ejecting liquid onto said medium;
determining whether or not to form said adjustment pattern again; and
if it is determined that said adjustment pattern is to be formed again, then forming said adjustment pattern-again in a position that differs from said predetermined position by ejecting liquid onto said medium.

13. A computer system comprising:
a computer; and
a liquid ejecting apparatus that is connected to said computer such that said liquid ejecting apparatus can establish wired or wireless communication with said computer,
wherein said liquid ejecting apparatus is capable of forming an adjustment pattern in a predetermined position on a medium by ejecting liquid onto said medium,
wherein, after forming said adjustment pattern, said liquid ejecting apparatus determines whether or not to form said adjustment pattern again, and
wherein, if it is determined that said adjustment pattern is to be formed again, then said liquid ejecting apparatus forms said adjustment pattern again in a position that differs from said predetermined position by ejecting liquid onto said medium.
